(19) United States
(12) Patent Application Publication
(10) Pub. No.: US 2003/0198548 A1
(43) Pub. Date: Oct. 23, 2003

(54) Apparatus and method for a controlled dump

(76) Inventor: Kenneth J. Stewart, Muskegon, MI (US)

Correspondence Address: Douglas H. Pauley, Pauley Petersen Kinne & Erickson, 2800 West Higgins Road, Suite 365, Hoffman Estates, IL, 60195, US

(21) Appl. No.: 10/127,627

(22) Filed: Apr. 22, 2002

(51) Int. Cl. B65G 65/23

(52) U.S. Cl. 414/425

(57) ABSTRACT

An apparatus and method for controllably dumping a container. A first lift line is operatively connected at a rotational axis of the container. The container is rotatable about the rotational axis between a loading position and a dumping position. A second lift line is movable in an upward direction to raise a free end portion of a pivot link to rotate the container about the rotational axis.

### BACKGROUND OF THE INVENTION

1. Field of the Invention

This invention relates to an apparatus and method for dumping a container. More specifically, this invention relates to an apparatus and method for controllably rotating a container about a rotational axis from a loading position to a dumping position.

2. Description of Related Art

Conventional containers, including for example dumpsters and drums, are used in industry and at work sites to store materials and/or debris. Occasionally, these containers are moved around the factory or work site using cranes and/or hoists. However, because of the size and weight of the containers and/or the materials within the containers, emptying the containers by removing or disposing the materials can be difficult. Further, conventional methods for removing or disposing of the materials from within the containers do not allow the operator to control the amount of material removed and/or the speed at which the materials are removed.

Conventional containers and/or methods for removing or disposing of the materials within the container do not allow a full controlled 180° rotation of the container.

There is an apparent need for an apparatus and method for dumping a container, wherein the container is rotatable about a rotational axis between a loading position and a dumping position in order to remove or dispose of the materials within the container, particularly in a controllable manner.

There is also an apparent need for an apparatus and method for dumping a container, which allows a fall controlled 180° rotation of the container.

### SUMMARY OF THE INVENTION

It is an object of the invention to provide an apparatus and method for rotating a container about a rotational axis from a first position to a second position to empty, dump or remove the materials from within the container.

It is another object of the invention to provide an apparatus and method for dumping the materials from within a container, wherein a rotation of the container about a rotational axis is controllable.

It is yet another object of the invention to provide an apparatus and method for returning a container to a first position from a second position after the materials are emptied, dumped or removed from the container, wherein a returning rotation of the container about a rotational axis is controllable.

The above and other objects of the invention are accomplished with an apparatus having an independently controllable first lift line which positions the container at a desired vertical distance from a support structure, such as a building floor or ground, and supports the container as the container is rotated to empty the contained materials.

The container is rotatable with respect to a rotational axis of the container, between the first position and the second position. Preferably, but not necessarily, the first lift line is pivotally connected with respect to each of a first side panel of the container and a second side panel of the container so that the container can freely rotate about the rotational axis. In one preferred embodiment of the invention, the container is rotatable within a range extending about 180°, between the first position and the second position.

The apparatus of the invention comprises a pivot link which is pivotally connected with respect to the container. Preferably, but not necessarily, the pivot link comprises a rigid material, for example steel or another suitable rigid material capable of supporting heavy materials. The rotation of the container, particularly during the dumping process, can be easily controlled with the rigid pivot link. However, a suitable flexible material, such as chain or cable, may be used to form at least a portion of the pivot link, depending upon the desired use for the container.

A first end portion of the pivot link is preferably pivotally connected to a first end portion of the container. Any suitable mechanical connection, direct or indirect, which allows the container to pivot or rotate with respect to the pivot link may be used for connecting the pivot link with respect to the container. Preferably, but not necessarily, the pivot link extends along a length of the container, for example to prevent or reduce lateral movement or shifting of the container with respect to the pivot link. In one preferred embodiment of the invention, the pivot link is positioned within a recessed area of a bottom panel of the container, so that the container rests on the floor or any generally flat, horizontal support surface without the container tipping or shifting. In certain embodiments of the invention, the pivot link extends along only a portion of the length of the container.

In one preferred embodiment of the invention, the apparatus further comprises a latching mechanism connected with respect to the container. The latching mechanism releasably maintains the pivot link when in a general horizontal position so that the pivot link does not free fall to the ground or support surface. Further, as the container rotates between 0° and 90°, for example through about a 45° position with respect to the first position, the latching mechanism releases the pivot link.

In one preferred embodiment of the invention, a method for a controlled dump includes rotating the container between the first position at about 0° and the second position at about 180°, to empty, dump or dispose of the materials within the container. The first lift line supports a weight of the container and any contents at the rotational axis. The first lift line carries a load weight of the container and any contents. The first lift line can be used to vary a vertical position or height of the container with respect to the ground or other support surface. The container can rotate about the rotational axis. A second lift line is independently moved or displaced in an upward direction.

Movement of the second lift line raises or lowers a free end portion of the pivot link with respect to the first end portion of the pivot link. As a result, a force applied to the free end portion creates a moment arm about the first end portion, which causes the container to rotate about the rotational axis. Upward movement of the free end portion of the pivot link moves the container towards the second position. The latching mechanism releases the pivot link as the container moves through the 90° position. The pivot link and the second lift line remain in a general vertical position as the container continues to rotate about the rotational axis. As the container rotates from the first position towards the second position, the container pivots about the first end portion of the pivot link. At the second position, a stop bracket prevents the container from further rotation about the rotational axis. The stop bracket is preferably connected with respect to the container to interfere with the first lift line at the second position. In certain embodiments of the invention, the degree of rotation of the container about the rotational axis can be predetermined, controlled or adjusted by positioning the stop bracket with respect to the first end portion of the pivot link.

Other objects and advantages of the present invention will be apparent to those skilled in the art from the following detailed description taken in conjunction with the appended claims and drawings.

### BRIEF DESCRIPTION OF THE DRAWINGS

The drawings show different features of an apparatus and method for dumping a container, according to preferred embodiments of this invention, wherein:

FIG. 1 is a plan side view of an apparatus for dumping a container, according to one preferred embodiment of this invention;

FIG. 2 is a top view of a container, according to one preferred embodiment of this invention;

FIG. 3 is a partial cross-sectional side view of a container through line A-A as shown in FIG. 2, according to one preferred embodiment of this invention;

FIG. 4 is a front view of a container, according to one preferred embodiment of this invention;

FIG. 5 is a side view of a latching mechanism connected to a pivot link in a generally horizontal position with respect to the ground, according to one preferred embodiment of this invention;

FIG. 6 is a side view of a latching mechanism released from a pivot link as a container rotates between a first position and a second position, according to one preferred embodiment of this invention;

FIG. 7 is a schematic side view of a container at a first position of about 0°, according to one preferred embodiment of the invention;

FIG. 8 is a schematic side view of a container at a rotated position of about 45° with respect to the first position, as the container rotates between the first position and the second position, according to one preferred embodiment of the invention;

FIG. 9 is a schematic side view of a container at a rotated position of about 90° with respect to the first position, as the container rotates between the first position and the second position, according to one preferred embodiment of the invention;

FIG. 10 is a schematic side view of a container at a rotated position of about 135° with respect to the first position, as the container rotates between the first position and the second position, according to one preferred embodiment of the invention;

FIG. 11 is schematic side view of a container at the second position of about 180° with respect to the first position, according to one preferred embodiment of the invention; and

FIG. 12 is a plan side view of an apparatus for dumping a container, according to one preferred embodiment of this invention;

FIG. 13 is a top view of a frame, according to one preferred embodiment of this invention;

FIG. 14 is a top view of a bottom portion of a frame, according to one preferred embodiment of this invention; and

FIG. 15 is a top view of a pivot link pivotally connected to a bottom portion of a frame, according to one preferred embodiment of this invention.

### DETAILED DESCRIPTION OF PREFERRED EMBODIMENTS

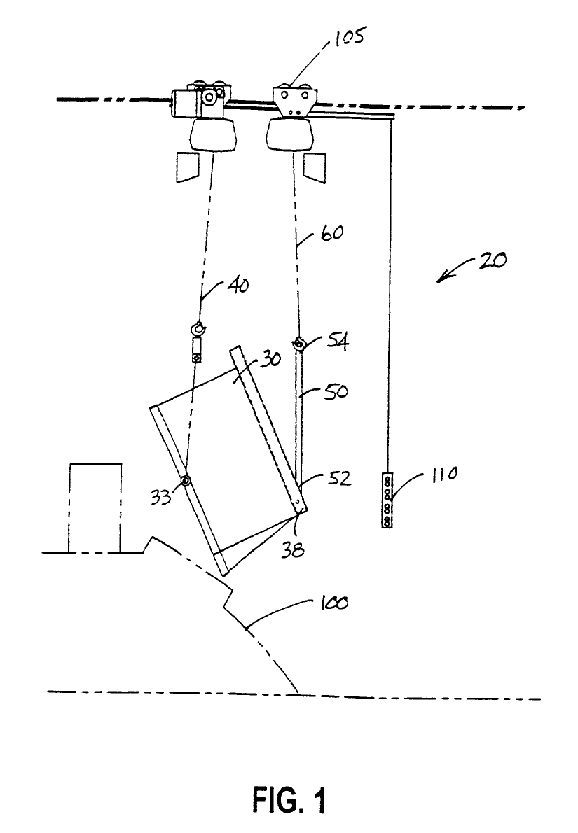

As shown in FIGS. 1-6, in one preferred embodiment of the invention, an apparatus 20 for controllably emptying or dumping a container 30 comprises an independently movable load carrying line or supporting member, for example a first lift line 40, operatively connected with respect to container 30. In one preferred embodiment of this invention, apparatus 20 is connected to container 30 at a pivot link 50. A second independently movable tilting line or supporting member, for example a second lift line 60, is operatively connected with respect to container 30 to tilt or rotate and pivot container 30. Preferably, but not necessarily, first lift line 40 and second lift line 60 are connected to a support system 105, for example a roller or pulley system, positioned with respect to container 30 to independently move container 30 with respect to a ground surface or other support surface 100 and/or rotate container 30 about a rotational axis 33, as shown in FIG. 1.

First lift line 40 carries a load weight of container 30 and any contents. Preferably, first load line 40 can be used to vary a vertical position or a height of container 30 with respect to the ground or support surface 100. For example, any suitable remote panel or control 110 may be in electrical or electromechanical communication with first lift line 40 to independently control the vertical positioning of container 30.

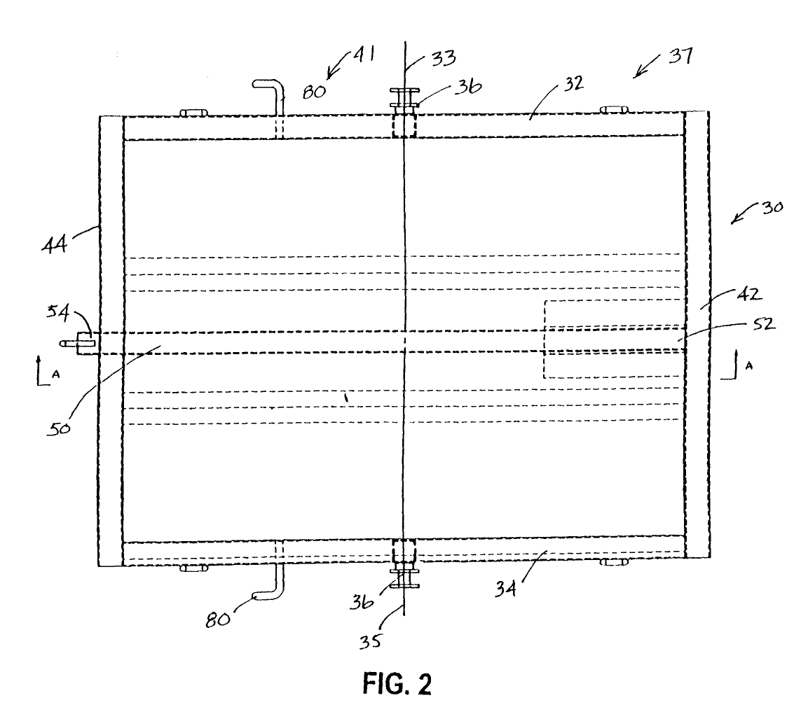

Referring to FIGS. 2 and 4, preferably, but not necessarily, first lift line 40 is pivotally connected to each of a first side panel 32 of container 30 and a laterally opposing second side panel 34 of container 30 at rotational axis 33, so that container 30 can freely rotate about rotational axis 33 between the first position and the second position. First lift line 40 can be connected to container 30 using any suitable direct or indirect mechanical connection. For example a projection, bearing or member 36 can be positioned with respect to container 30 to connect first lift line 40 to container 30. Member 36 may be suitably connected to container 30 or may be integrated with container 30.

Rotational axis 33 may be located at any position with respect to container 30 which allows container 30 to rotate freely about rotational axis 33. Preferably, rotational axis 33 is located or positioned on a vertical plane 35, as shown in FIG. 2. The term “vertical” refers to a position with respect to a generally horizontal ground surface, wherein a force of gravity acts upon container 30 to urge or pull container 30 towards the ground surface. Preferably, container 30 is rotatable within a range extending about 180°, between the first position and the second position. For example, if the first position has a reference point of about 0°, container 30 can rotate about 180° with respect to the first position, to a second position. Further, container 30 is rotatable from the second position to the first position, after the materials are emptied from container 30, for example.

Container 30 may have any suitable shape and size, depending upon the purpose for which container 30 is used. For example, container 30 may have a general rectangular shape, or a cylindrical or drum shape, having a general circular cross-sectional area. Further, container 30 may be formed or fabricated from any suitable material including, but not limited to, metal, alloys, composites, plastics and wood.

In one preferred embodiment of the invention, apparatus 20 comprises pivot link 50 pivotally connected with respect to container 30. Preferably, but not necessarily, pivot link 50 comprises a rigid material, for example steel or another suitable rigid material capable of supporting heavy materials. The rigid material of pivot link 50 provides increased controllability of container 30, particularly as the contained materials are emptied or dumped. However, a flexible material may be used to form or fabricate at least a portion of pivot link 50, depending upon the size, weight and intended use of container 30. Such suitable flexible materials include, but are not limited to, cable, chain and rope.

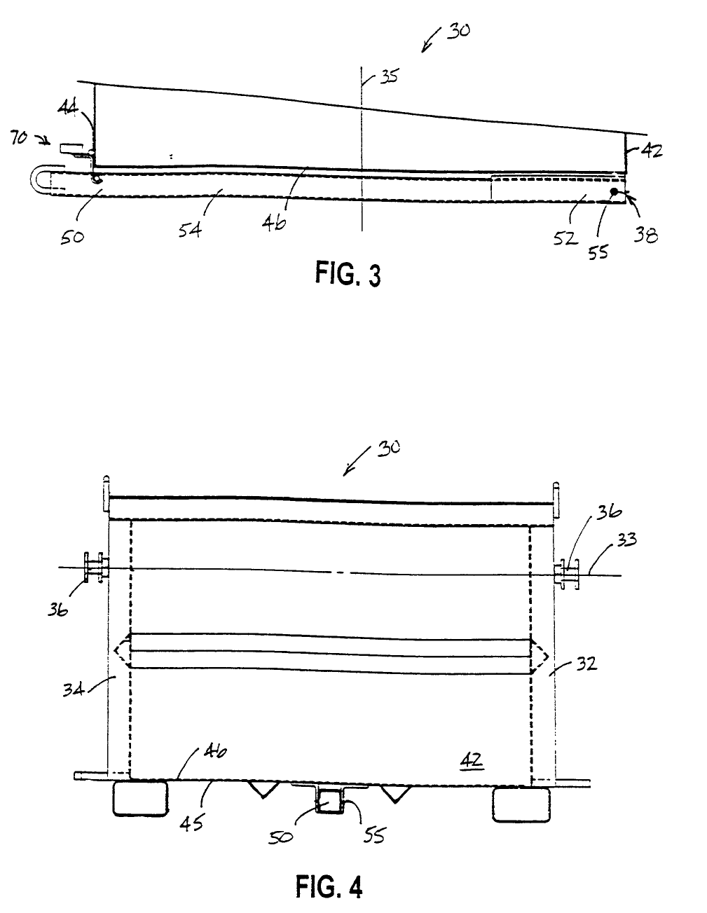

Referring to FIGS. 2 and 3, pivot link 50 is preferably connected at a first end portion 52 to a first end portion 38 of container 30. Any suitable mechanical connector, direct or indirect, may be used for connecting pivot link 50 with respect to container 30, which allows container 30 to pivot about first end portion 52. For example, pivot link 50 may be connected to container 30 using a bolt or pin 55, as shown in FIG. 3.

As shown in FIG. 1, in one preferred embodiment of the invention, a second or free end portion 54 of pivot link 50, opposite first end portion 52, may be operatively connected or attached to second lift line 60. As shown in FIGS. 2 and 3, when container 30 is in the first position, pivot link 50 extends along a length of container 30 between a first end panel 42 of container 30 and an opposite second end panel 44 of container 30. At least a portion of free end portion 54 may extend past the second end panel 44. In one preferred embodiment of the invention, pivot link 50 contacts at least a portion of an outer surface 45 of a bottom panel 46 of container 30, when container 30 is in the first position.

In one preferred embodiment of the invention, first end portion 52 is pivotally connected with respect to container 30 on a first side 37 of vertical plane 35 and free end portion 54 is freely movable on a second side 41 of vertical plane 35. Preferably, first end portion 52 is connected at first end portion 38 of container 30. However, in certain embodiments of the invention, first end portion 52 may be positioned at any location between first end portion 38 and vertical plane 35. Further, free end portion 54 may extend along container 30 between vertical plane 35 and second end portion 39. As shown in FIGS. 2 and 3 for example, free end portion 54 extends beyond second end portion 39. Alternatively, pivot link 50 may extend along only a portion of container 30, with first end portion 52 positioned on first side 37 and free end portion 54 freely movable on second side 41.

Preferably, pivot link 50 extends along a bottom panel 46 of container 30, for example to prevent or reduce lateral tilting or shifting of container 30 with respect to pivot link 50, particularly while container 30 is being emptied. Bottom panel 46 may form a recessed area or an indentation for receiving pivot link 50. Thus, pivot link 50 is positionable within the recessed area of bottom panel 46. As a result, container 30 is stable when positioned on support surface 100. In certain embodiments of the invention, pivot link 50 may have any suitable width. For example, pivot link 50 may have a width about equal to a width of container 30 or pivot link 50 may have a width less than or greater than a width of container 30.

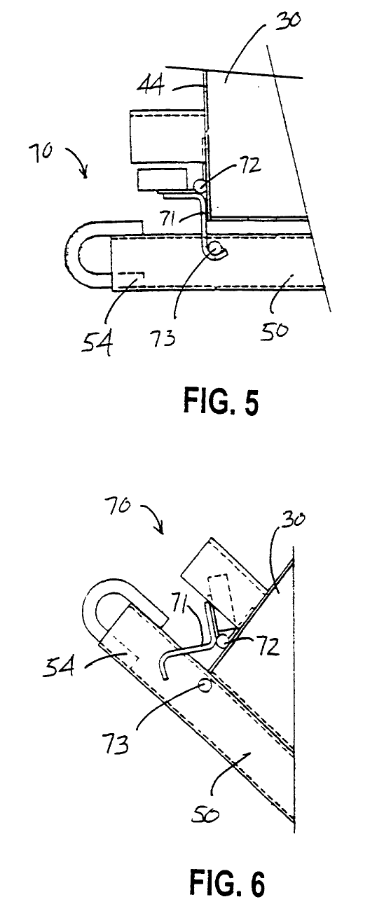

In one preferred embodiment of the invention, apparatus 20 further comprises a latching mechanism 70 connected with respect to container 30, as shown in FIGS. 5 and 6. Latching mechanism 70 releasably maintains pivot link 50 when in a general horizontal position, such as shown in FIG. 5, so that pivot link 50 does not free fall towards support surface 100. Further, as container 30 rotates from the first position to the second position, latching mechanism 70 releases from pivot link 50, no as shown in FIG. 6.

In one preferred embodiment of the invention, latching mechanism 70 comprises a bracket 71 hingedly attached with respect to container 30. For example, bracket 71 may be connected or attached to end panel 44 with a hinge 72 or other suitable mechanical connection. Bracket 71 is engageable with a member or pin 73 connected or attached with respect to pivot link 50. Preferably, pin 73 is integrated with or connected to pivot link 50. Pin 73 may be connected to pivot link 50 using any suitable mechanical connection. For example, pin 73 may be welded to pivot link 50. As shown in FIG. 5, when container 30 is positioned in a generally horizontal position with respect to the ground, bracket 71 is engaged with pin 73 to maintain pivot link 50 in a generally horizontal position. As shown in FIG. 6, as container 30 rotates between the first position and the second position, bracket 71 releases from pivot link 50 and container 30 continues to rotate towards the second position. As container 30 continues to rotate towards the second position, container 30 pivots about pivot link 50 at first end portion 52.

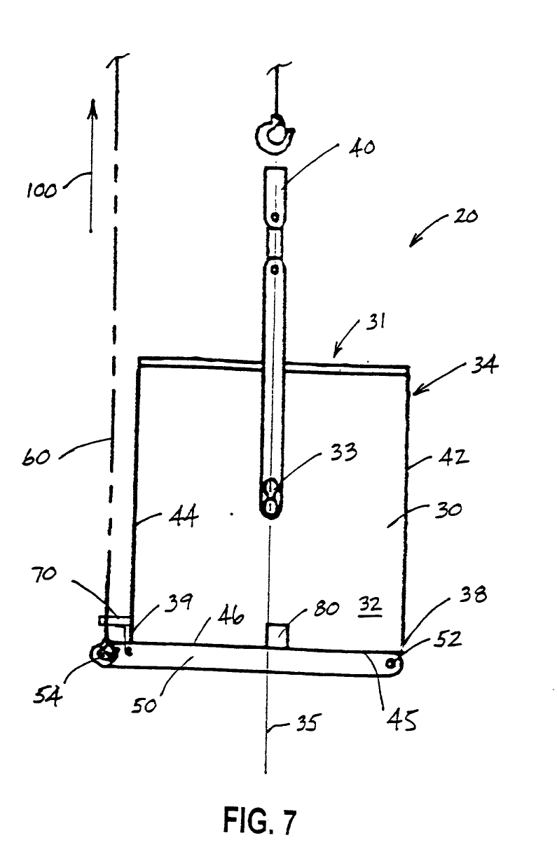

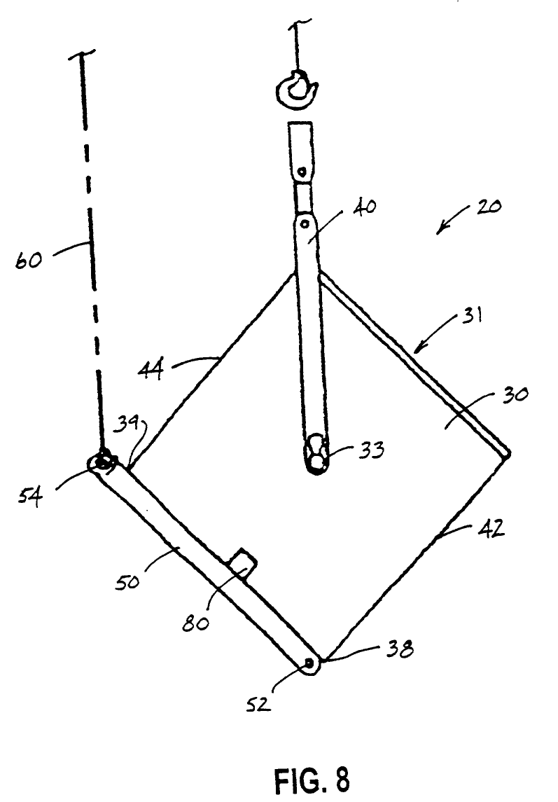

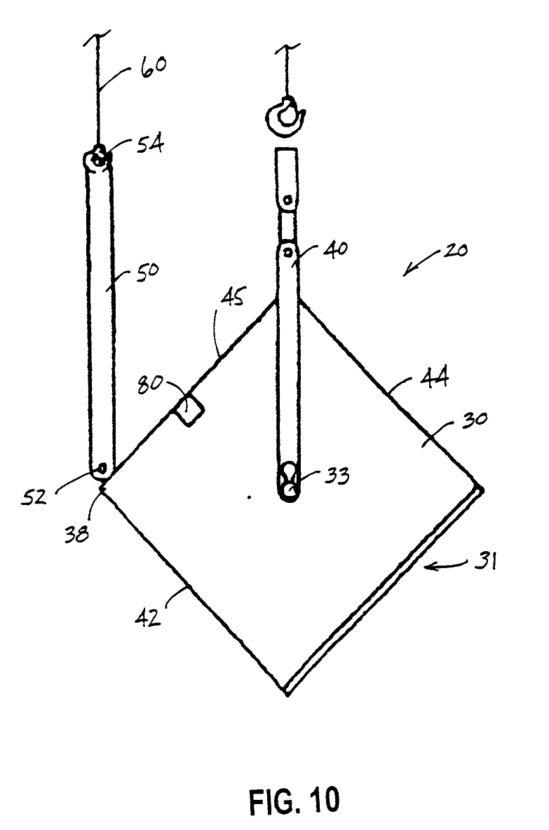

In one preferred embodiment of the invention, a stop bracket 80, as shown in FIGS. 7-11, or any suitable stop structure can be connected with respect to container 30 to interfere with first lift line 40 with container 30 at the second position, to prevent rotation of container 30 beyond the second position. Further, stop bracket 80 positions first lift line 40 so that the weight of container 30 acting upon first lift line 40 biases or urges container 30 towards the 90° position, after the material is emptied or removed from within container 30. Thus, container 30 is urged in a return direction to rotate from the second position towards the first position. After container 30 returns to the first position, latching mechanism 70 is engageable with pivot link 50 to maintain container 30 in a generally horizontal position.

As container 30 rotates from the second position to the first position, second lift line 60 is movable in a downward direction. Downward movement of second lift line 60 causes free end portion 54 to move in a downward direction, urging container 30 to pivot about first end portion 52. In the first position, pivot link 50 is in a generally horizontal position.

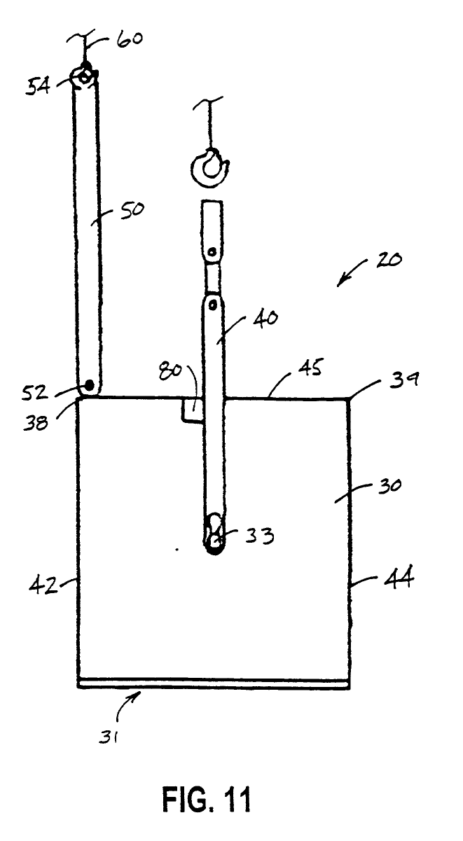

Referring to FIGS. 7-11, in one preferred embodiment of the invention, container 30 is rotatable about rotational axis 33 between the first or loading position (FIG. 7) and the second or dumping position (FIG. 11), to empty, dump or remove the materials from within container 30. First lift line 40 supports the weight of container 30 and any contents at rotational axis 33, to allow container 30 to rotate with respect to rotational axis 33. Second lift line 60 can be independently moved or displaced in an upward direction, as shown by arrow 100 in FIG. 7.

Preferably, the first position, as shown in FIG. 7, is generally horizontal, wherein an opening 31 of container 30 faces upward, for example away from the ground or support surface 100. Thus, container 30 can be loaded with materials or debris, for example, without spillage. The second position, as shown in FIG. 11, is preferably generally horizontal, however, with opening 31 facing downward, for example towards the ground or support surface 100, whereby the materials or debris contained within container 30 are emptied, dumped or removed from container 30. Opening 31 may have any suitable configuration and/or dimensions, depending upon the materials intended to be held or contained within container 30.

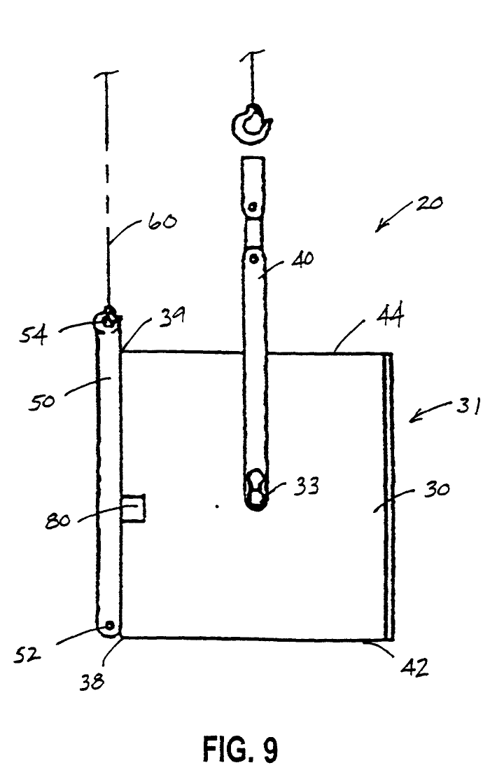

Movement of second lift line 60 raises free end portion 54 of pivot link 50 with respect to first end portion 52 of pivot link 50. As a result of raising free end portion 54 with respect to first end portion 52, a force is applied to free end portion 54, which creates a moment arm about first end portion 52 to cause container 30 to rotate about rotational axis 33. Thus, upward movement of free end portion 54 moves container 30 towards the second position. Latching mechanism 70 is released from pivot link 50 as container 30 moves between 0° and 90°, for example through about a 45° position. Preferably, but not necessarily, pivot link 50 and second lift line 60 remain in a general vertical position as container 30 continues to rotate about rotational axis 33, as shown in FIGS. 9-11. As container 30 continues to rotate from the first position towards the second position, container 30 pivots about first end portion 52 of pivot link 50. At the second position, stop bracket 80 prevents container 30 from further rotation about rotational axis 33.

The weight of container 30 acting upon first lift line 40 urges container 30 towards the first position, after the material has been emptied or removed from within container 30. After returning to the first position, linking mechanism 70 is engageable with pivot link 50 to retain container 30 in the first position.

It is apparent to those having ordinary skill in the art that the allowable degree of rotation of container 30 can be controlled or adjusted by vertical displacement or movement of first lift line 40 and/or second lift line 60. Stop bracket 80 can be positioned differently with respect to first end portion 52 of pivot link 50, to achieve more or less rotation. For example, by positioning stop bracket 80 relatively closer to first end portion 52, container 30 may rotate more than about 180°. Conversely, by placing stop bracket 80 relatively farther from first end portion 52, container 30 will rotate less than about 180°.

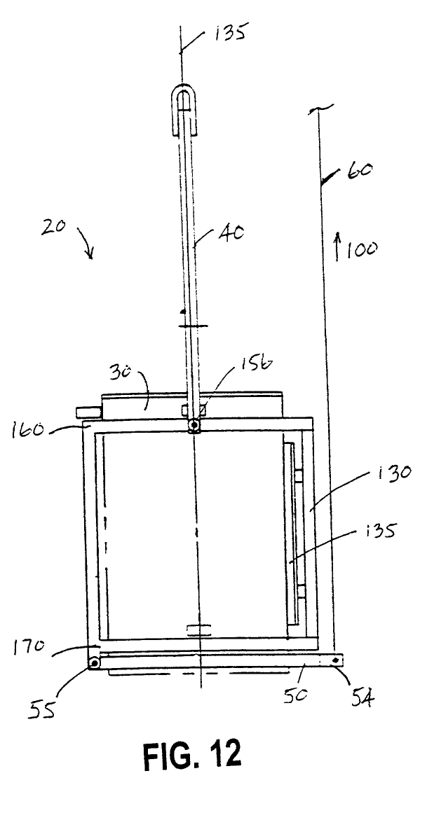

As shown in FIGS. 12-15, in one preferred embodiment of this invention, apparatus 20 comprises a support frame 130 for supporting container 30 as container 30 is controllably emptied or dumped. Preferably, but not necessarily, container 30 generally has a cylindrical or drum shape, having a general circular cross-sectional area, in this embodiment of the invention.

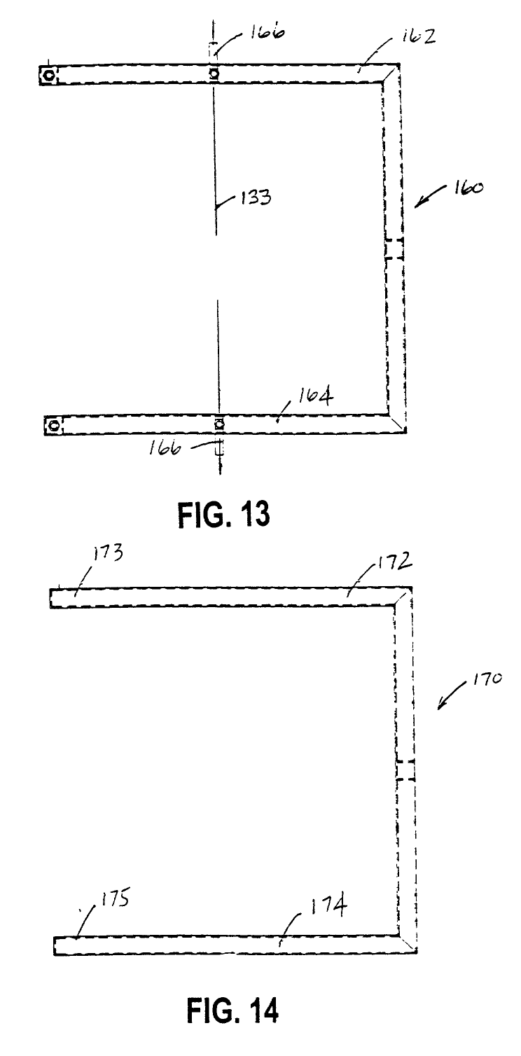

Support frame 130 comprises an upper or top portion 160 (FIG. 13) and a lower or bottom portion 170 (FIG. 14), connected to upper portion 160. Support frame 130 is positionable with respect to container 30 so that upper portion 160 and lower portion 170 retain container 30 in a general upright position and prevent container 30 from undesirably tipping, for example as container 30 is being rotated between the first position to the second position. In one preferred embodiment of this invention, first lift line 40 is pivotally connected at rotational axis 133 to upper portion 160 at each of a first extension 162 and a laterally opposing second extension 164, so that support frame 130 can freely rotate about rotational axis 133. First lift line 40 can be connected to support frame 130 using any suitable direct or indirect mechanical connection. For example, first lift line 40 is preferably pivotally connected to upper portion 160 at laterally opposing pins 166, as shown in FIG. 13. Preferably, but not necessarily, each extension 166 is attached or connected to upper portion 160 using any suitable mechanical connection, for example, a weld. Alternatively, it is apparent that extensions 166 can be formed or integrated with upper portion 160.

Rotational axis 133 may be located at any position with respect to support frame 130 which allows support frame 130 to rotate freely about rotational axis 133. Preferably, rotational axis 133 is located or positioned on a vertical plane 135, as shown in FIG. 12. The term “vertical” refers to a position with respect to a generally horizontal ground surface, wherein a force of gravity acts upon support frame 130 to urge or pull support frame 130 towards the ground surface. Preferably, support frame 130 is rotatable within a range extending about 180°, between a first position and a second position. For example, if the first position has a reference point of about 0° (FIG. 12), support frame 130 can rotate about 180° with respect to the first position, to a second position. Further, support frame 130 is rotatable from the second position to the first position, after the materials are emptied from container 30, for example.

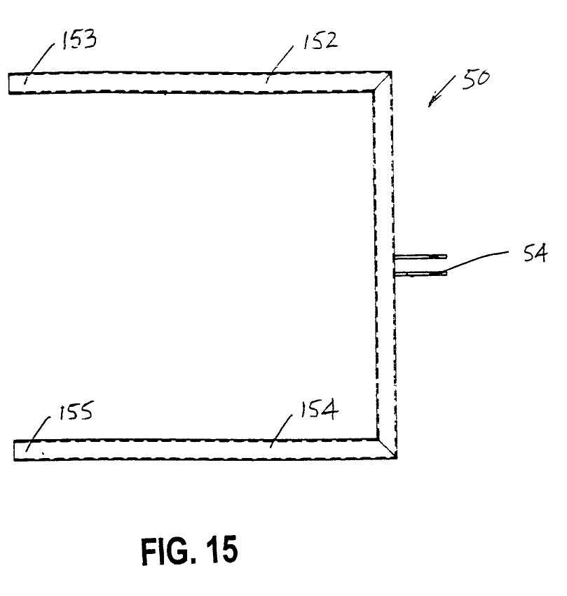

As shown in FIG. 14, bottom portion 170 comprises a first extension 172 having an end portion 173 and a second extension 174 having an end portion 175. In one preferred embodiment of this invention, pivot link 50 is pivotally connected to bottom portion 170 at end portions 173 and 175. Referring to FIGS. 14 and 15, pivot link 50 preferably comprises a first extension 152 pivotally connectable at an end portion 153 to end portion 173 and a second extension 154 pivotally connected at an end portion 155 to end portion 175. Any suitable mechanical connector, direct or indirect, may be used for connecting pivot link 50 with respect to support frame 130, which allows support frame 130 to pivot about pivot link 50 at end portions 152 and 154. For example, pivot link 50 may be connected to bottom portion 170 using bolts or pins 55, as shown in FIG. 12. Second or free end portion 54 of pivot link 50 preferably is operatively connected or attached to second lift line 60.

In one preferred embodiment of this invention, support frame 130 is positionable with respect to container 30 and support frame 130, and container 30, are rotatable about rotational axis 133 between the first or loading position and the second or dumping position, to empty, dump or remove the materials from within container 30. As shown in FIG. 12, a vacuum device 135, for example, fixes a position of container 30 with respect to support frame 130. First lift line 40 supports the weight of support frame 130, container 30 and any contents at rotational axis 133, to allow support frame 130 to rotate with respect to rotational axis 133. Second lift line 60 can be independently moved or displaced in an upward direction, as shown by arrow 100 in FIG. 12.

Preferably, the first position is generally horizontal, wherein opening 31 of container 30 faces upward, for example away from the ground or support surface 100. Thus, container 30 can be loaded with materials or debris, for example, without spillage. The second position is preferably generally horizontal, however, with opening 31 facing downward, for example towards the ground or support surface 100, whereby the materials or debris contained within container 30 are emptied, dumped or removed from container 30.

Movement of second lift line 60 raises free end portion 54 of pivot link 50 with respect to end portions 153 and 155. As a result of raising free end portion 54 with respect to end portions 153 and 155, a force is applied to free end portion 54, which creates a moment arm about end portions 153 and 155 to cause support frame 130 to rotate about rotational axis 133. Thus, upward movement of free end portion 54 moves support frame 130 towards the second position. As support frame 130 continues to rotate from the first position towards the second position, end portions 173 and 175 pivot about end portion 153 and end portion 155 of pivot link 50, respectively.

While in the foregoing specification the invention has been described in relation to certain preferred embodiments, and many details are set forth for purpose of illustration, it will be apparent to those skilled in the art that the invention is susceptible to additional embodiments and that certain of the details described in the specification and in the claims can be varied considerably without departing from the basic principles of the invention.

We claim:

1. An apparatus for rotating a container between a first position and a second position, the apparatus comprising:
a support member connected with respect to the container, the container rotatable with respect to a rotational axis of the container between the first position and the second position; and
a pivot link having a first end portion pivotally connected with respect to the container and extending along at least a portion of a length of the container, and a free end portion of the pivot link movable with respect to the first end portion.

2. The apparatus of claim 1 further comprising a movable second member connected with respect to the free end portion.

3. The apparatus of claim 1 wherein the support member comprises a first lift line operatively connected at each of a first side panel of the container and a laterally opposing second side panel of the container.

4. The apparatus of claim 1 wherein the pivot link contacts at least a portion of a bottom panel of the container, with the container in the first position.

5. The apparatus of claim 1 wherein the pivot link extends between a first end panel of the container and an opposite second end panel of the container.

6. The apparatus of claim 1 wherein the pivot link is connected at the free end portion to a second lift line.

7. The apparatus of claim 1 further comprising a latching mechanism connected with respect to the container, and the latching mechanism releasably connected to the pivot link.

8. The apparatus of claim 7 wherein the latching mechanism is releasable from the pivot link as the container pivots with respect to the first end portion.

9. The apparatus of claim 1 further comprising a stop bracket connected to the container, and the stop bracket interfering with the support member, with the container in the second position.

10. The apparatus of claim 1 wherein the container is rotatable within a range extending about 180° between the first position and the second position.

11. The apparatus of claim 1 wherein the pivot link is received within a recessed area formed in a bottom panel of the container.

12. The apparatus of claim 1 wherein the pivot link is rigid.

13. The apparatus of claim 1 wherein the pivot link is flexible.

14. The apparatus of claim 1 wherein the first end portion is positioned on a first side of a vertical plane generally extending through the rotational axis, and the free end portion is movable on a second side of the vertical plane.

15. An apparatus for controllably rotating a container about a rotational axis of the container between a first position and a second position, the apparatus comprising:
a first lift line operatively connected to the container, the container rotatable about a rotational axis of the container between the first position and the second position;
a second lift line;
a pivot link having a first end portion pivotally connected with respect to the container and an opposite free end portion attached to the second lift line, the pivot link extending between a first end panel of the container and an opposite second end panel of the container; and
the second lift line movable in a generally vertical direction to rotate the container about the rotational axis.

16. The apparatus of claim 15 further comprising a latching mechanism connected with respect to the container, and the latching mechanism releasably maintaining the pivot link in a horizontal position, with the container in the first position.

17. The apparatus of claim 16 wherein the latching mechanism releases from the pivot link as the container rotates from the first position and the second position.

18. The apparatus of claim 15 further comprising a stop bracket connected with respect to the container, and the stop bracket interfering with the first lift line, with the container in the second position.

19. The apparatus of claim 15 wherein the container is rotatable within a range extending about 180° between the first position and the second position.

20. The apparatus of claim 15 wherein the first lift line is operatively connected to each of a first side panel of the container and an opposite second side panel of the container.

21. The apparatus of claim 15 wherein the first lift line and the second lift line each is independently movable.

22. The apparatus of claim 15 wherein the pivot link comprises one of a chain, a cable and a rope.

23. A method for controllably rotating a container about a rotational axis of the container between a first position and a second position, the method comprising the steps of:
supporting the container using a first lift line, the container rotatable about the rotational axis between the first position and the second position;
moving a second lift line attached to a first end portion of a pivot link and applying a force with an upward force component to the first end portion;
controllably rotating the container to the second position; and
preventing the container from rotating beyond the second position.

24. The method of claim 23 further comprising the step of releasing a latching mechanism from the pivot link as the container rotates between the first position and the second position.

25. The method of claim 24 wherein the container pivots with respect to a second end portion of the pivot link as the container rotates between the first position and the second position.

26. The method of claim 23 wherein the container rotates within a range extending about 180° between the first position and the second position.

27. The method of claim 23 further comprising the step of biasing the container towards a 90° position to rotate the container from the second position towards the first position.

28. An apparatus for dumping a container, the apparatus comprising:
the container rotatable about a rotational axis of the container, the rotational axis positioned within a vertical plane;
a supporting member connected with respect to the container at the rotational axis;
a pivot link having a first end portion and a second end portion opposite the first end portion, the first end portion pivotally connected with respect to the container on a first side of the vertical plane, the second end portion freely movable on a second side of the vertical plane; and
a movable second member connected with respect to the second end portion.

29. An apparatus for rotating a container between a first position and a second position, the apparatus comprising:
a support frame connected with respect to the container, the support frame rotatable with respect to a rotational axis of the support frame between the first position and the second position; and
a pivot link having a first end portion pivotally connected to the support frame and extending along at least a portion of a length of the support frame, and a free end portion of the pivot link movable with respect to the first end portion.
